(19) United States
(12) Patent Application Publication
(10) Pub. No.: US 2005/0268864 A1
(43) Pub. Date: Dec. 8, 2005

(54) Removable pet tag collar device

(76) Inventors: John D. Gallagher, Raleigh, NC (US); Pamela Jean Gallagher, Raleigh, NC (US)

Correspondence Address: MACCORD MASON PLLC, 300 N. GREENE STREET, SUITE 1600, P. O. BOX 2974, GREENSBORO, NC, 27402, US

(21) Appl. No.: 10/861,845

(22) Filed: Jun. 4, 2004

(51) Int. Cl. A01K 27/00

(52) U.S. Cl. 119/858

(57) ABSTRACT

A pet collar with quick-release tag fastener allowing for easy attachment and removal of pet identification tags to collars, wherein the pet tags are releasably attachable without requiring the use of any tools for securing and/or releasing the tags from the fastener and/or the collar.

### BACKGROUND OF THE INVENTION

(1) Field of the Invention

The present invention relates generally to pet accessories and, more particularly, to a pet collar with a quick-release tag fastener.

(2) Description of the Prior Art

Pet owners are required to identify their pets with a registration and/or vaccination tag that is replaced on a periodic basis. These tags are attached to the pet's collar. Additionally, pet owners often place a pet's name, address, and owner contact information on their pet in case the pet becomes lost. This information is generally attached to the pet's collar in the form of a tag.

The typical available method of attaching these tags to pet collars consists of either a metal S-hook or circular wire, such as a spiral clip, that is attached to a collar's D-ring. The method of attaching one or more tags to either the S-hook or circular wire is cumbersome and/or requires the use of at least one tool.

Prior art related to this invention is as follows:

U.S. Pat. No. 6,305,329 issued to Levy, Jr. on Oct. 23, 2001 for a product with identification tag teaches a combination of a product, such as a pet collar, and an identification tag device attached thereto that serves an alternate function. In the preferred embodiment, the collar includes a buckle having a recessed surface adapted for attachment of an identification tag and clear overlay.

U.S. Pat. No. 4,739,566 issued to Smith on Apr. 26, 1988 for a Pet tag holder teaches a holder for pet tags which is attached to a typical pet collar. To prevent the tags from rattling, the holder has a flexible extension, which secures on the tags when the holder is folded around the tags. The tags are secured to the holder by attachment utilizing the hole provided in the tag such as a screw. The tags are easily removed or inserted by opening a flap on the holder and in the preferred embodiment unfastening a screw in the holder which threads through the tag holes and into a self-threading screw-hole molded in the body of the tag holder.

U.S. Pat. No. 4,259,798 issued to McConnell on Apr. 7, 1981 for Pet tag holder teaches a holder for supporting a pair of pet tags while preventing rattling therebetween comprising an elongated base member having means at one end for connection to a pet collar and carrying a post on a second end for engaging a hole in pet tags. A pair of spring arms are carried by the base member and have free ends spaced in opposition about the post to urge the tags against the base member to thereby prevent rattling. In a preferred form the base member comprises a flat plate having dimensions comparable to a pet tag and providing a surface for carrying identifying indicia.

U.S. Pat. No. 4,137,660 to Dettmann, et al. on Feb. 6, 1979 for Identification holders for dogs and cats teaches an identification tag for a dog, cat or the like is carried by a holder fastened to a collar, harness or leash. The holder comprises a transparent plastic pocket open at one end secured to the collar and overlaid by a protecting strap held in place by a rivet at one end and a snap fastener at the open end of the pocket permitting the strap to be lifted or rotated about the rivet to insert an elongated identification tag or to view identification information.

U.S. Pat. No. 6,325,024 for Masukawa on Dec. 4, 2001 for Collar for pet teaches a collar for a pet comprises a band to be wound around the neck of a pet and a primary decoration that imitates part of a piece of clothing worn by a person. The decoration has an upper edge extending as an arcuate ascending curve from the rear of the neck of the pet to the front when the collar is put around the neck of the pet. An element, which partially overlaps with the primary decoration allows a detachable added decoration to be attached to the band. This attachment element is not seen from outside. The band is prevented from turning by any one of various mechanism.

U.S. Pat. No. 4,245,486 Matsumoto, et al. on Jan. 20, 1981 for Retractable charm device teaches a retractable charm device having a two part body formed in a desired shape, movable appendages extending from the body, mechanical mechanism mounted within the body, the mechanical mechanism including two support panels attached to each other, a plurality of gears rotatably mounted between the two support panels on axles, a cam affixed to one of said gears for actuating the movable appendages through cam follower structure, a take-up spool affixed for rotation with one of the gears, an energization cord attached to the take-up spool, a spring fixed at one end to one gear and at the other end to an element of one panel, a guided element for the energization cord mounted on one panel, and structure attached to the other end of the energization cord for permitting a pull to be exerted on the cord to unwind same from the take-up spool and thus, in turn, energize the spring for later actuation of the mechanical mechanism and the movable appendages.

U.S. Pat. No. 6,334,239 to Kraut for Jan. 1, 2002 for Key holder teaches a key and memo pad holder which includes a garment clip in the form of an alligator clip having a bar like jaw to which a main key loop is detachably connected. The main key loop includes a slidably disposed sleeve on one end to form a closure, and one or more variously sized auxiliary split key rings on said main key loop to accommodate keys having different size key openings.

United States Patent Application Pub. No. 20030033737 to Bradshaw, Jennifer et al. on Feb. 20, 2003 for Pet tag holder teaches a holder for securing, silencing and protecting pet tags to a typical pet collar is provided. The holder includes an opening at one end allowing insertion of pet tags therein and an attachment opening allowing attachment therethrough of pet tags to a pet collar.

United States Patent Application Pub. No. 20030217703 to Kiss, Deborah on Nov. 27, 2003 for Pet accessory teaches a pet accessory which allows for easy disassembly or removal of a collar without requiring the user to detach identification tags or the like from the collar. The collar comprises a first portion and a second portion, which are releasably attached to each other to form a loop to pass around a pet's neck. The first portion preferably provides means for adjusting the overall length of the accessory. The second portion preferably provides means for attaching identification tags, vaccination tags, and the like.

Given the amount of information that can be incorporated into tags, especially electronic tags and the desire to personalize a pet's accoutrements, a need exists for a pet collar with a quick-release tag fastener that does not require tools. The use of the word “tool(s)” throughout the application should be understood as any device or implement used to pry open/apart the current attachment devices, such as an S-hook or circular ring. None of these prior art devices provide for a pet collar with a quick-release tag fastener that does not require at least one tool for attaching or removing a tag. Thus, there remains a need for a pet collar with a quick-release tag fastener that can quickly and easily attach and release at least one tag without the need for tools.

### SUMMARY OF THE INVENTION

The present invention is directed to a pet collar with a quick-release tag fastener. The present invention is further directed to a method for releasably securing pet tag collars.

Thus, the present invention provides for a collar with a connector and a clasp with an attachment end and a clasp end, wherein the clasp is permanently fixed to the collar at the attachment end; and wherein the clasp end is connected and configured to provide for releasable attachment of the pet tag(s); thereby providing for the quick and easy releasable attachment of at least one pet tag without the need for tools.

The present invention further provides a method for releasably securing pet tags to collars, the method steps including: providing a collar with a connector and a clasp with an attachment end and a clasp end; fixing the clasp permanently to the collar at the attachment end; connecting and configuring the clasp end to provide for releasable attachment of the pet tag(s); opening the clasp; inserting the clasp through the pre-drilled hole in at least one tag; and closing the clasp; thereby providing for the quick and easy releasable attachment of at least one pet tag without the need for tools.

### BRIEF DESCRIPTION OF THE DRAWINGS

FIG. 1 is a perspective view of a pet collar with quick-release tag fastener constructed according to the present invention.

FIG. 2 is a perspective view of another embodiment of a pet collar with quick-release tag fastener constructed according to the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

Referring now to the drawings in general, the illustrations are for the purpose of describing a preferred embodiment of the invention and are not intended to limit the invention thereto.

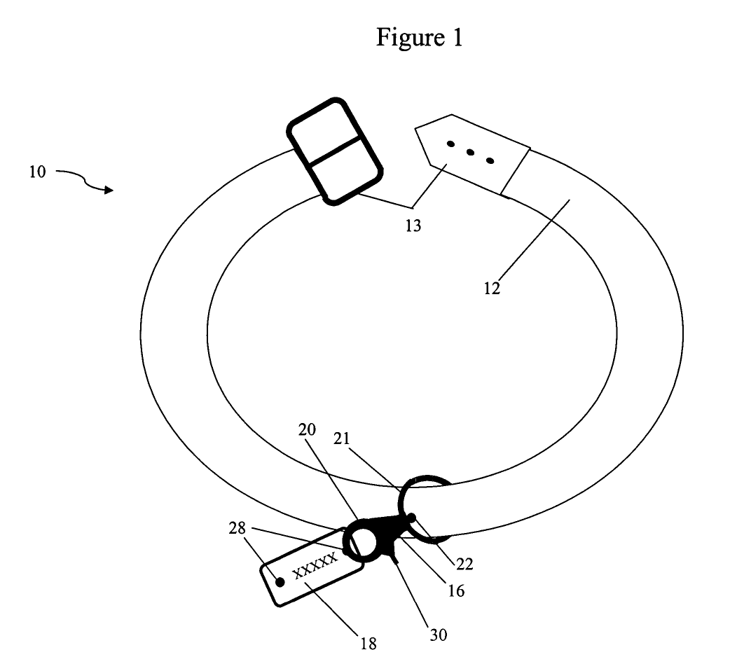

The present invention is a pet collar with quick-release tag fastener, generally referenced as 10 in FIG. 1, including a pet collar 12 with connector 13, and clasp 16, constructed to attach and release at least one tag 18 in a quick and reversible manner with no tools.

The pet collar 12 is meant to include any belt or belt-like device that goes around a portion of an animal. The pet collar may be made from any number of materials, including, but not limited to, leather, nylon webbing, cotton webbing, reinforced fabric, metal chain link, and the like. The collar also includes a connector 13 to connect the ends around the pet's neck or other body area. For example, the connector can be a buckle, snap buckle, buttons, hook-and-loop fastener, and the like.

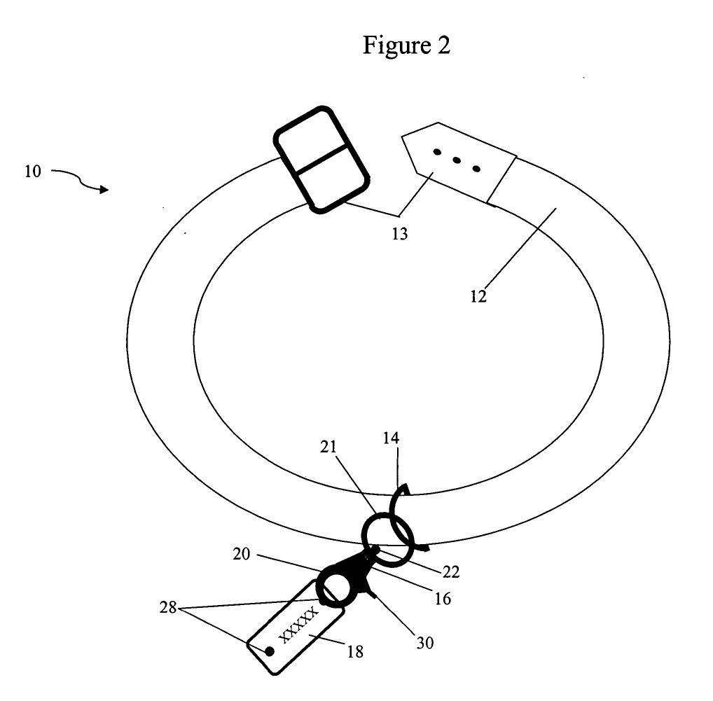

As seen in FIG. 2, the collar also preferably includes a permanently attached D-ring 14. The D-ring is preferably composed of metal or plastic and is preferably looped through and sewn securely to the collar.

The clasp 16 includes a clasp 20 with an attachment end 21, preferably with a swivel 22. The clasp preferably uses a spring-release mechanism 30 and is preferably made of metal, although other durable material can be used. For example, plastic clasps can be used to reduce the weight of the clasp. The attachment end is either looped through and sewn securely to the collar, as seen in FIG. 1, or permanently attached to the D-ring, as seen in FIG. 2.

The metal D-ring 14 runs through the attachment end 21, thereby permanently securing the swivel clasp to the collar. The attachment end is inserted through the opening (not shown) of the D-ring, prior to the D-ring being fastened to the collar.

In order to attach the clasp to the D-ring, the opening of the D-ring must be enlarged to accommodate the attachment end of the clasp. The clasp is inserted into the D-ring through the enlarged opening. The D-ring opening is then permanently closed to its original position. The D-ring and attached swivel clasp are now available for standard assembly into the pet collar.

After the D-ring and attached swivel clasp are permanently affixed to the pet collar, the at least one pet information tag 18 can be attached.

Pet tags come with pre-drilled holes 28 from their various manufacturers. These holes allow for attachment to the clasp. The spring-release mechanism 30 of the swivel clasp is manually activated with the thumb or finger to open the clasp. The at least one pet information tag is then threaded into the open swivel clasp. After the at least one pet information tag is inserted into the clasp, the spring-release mechanism is released, allowing the clasp opening to close.

The present invention thus provides a pet collar that allows attachment and removal of one or more pet tags quickly and easily without the use of tools.

The present invention further provides a method for releasably securing pet tags to collars, the method steps including: providing a collar with a connector and a clasp with an attachment end and a clasp end; fixing the clasp permanently to the collar at the attachment end; connecting and configuring the clasp end to provide for releasable attachment of the pet tag(s); opening the clasp; inserting the clasp through the pre-drilled hole in at least one tag; and closing the clasp; thereby providing for the quick and easy releasable attachment of at least one pet tag without the need for tools.

The pet tags can be functional or decorative. For example, functional tags can be information tags, such as rabies vaccination tags, name tags, and owner identification tags, and may also include RFID devices, electronic veterinary records, and the like. Decorative tags, such as medallions, ribbons, charms, jewelry, and the like may also be used.

In one embodiment, the present invention utilizes a clasp to reversibly attach information tags and/or decorative tags without the use of tools, or any device or implement used to pry open/apart prior art attachment devices such as S-hooks or circular rings. Preferably, all tags are readily releasably removable using the present invention in order to permit easy collar changes without requiring the use of tools, devices, or implements as set forth herein above. However, because the collar contains a substantially permanently attached ring, such as the D-ring or clasp attachment end, information tags that may need to be substantially permanently attached, such as Rabies vaccination tags, can still be attached to the collar's D-ring via traditional methods.

Certain modifications and improvements will occur to those skilled in the art upon a reading of the foregoing description. All modifications and improvements have been deleted herein for the sake of conciseness and readability but are properly within the scope of the following claims.

1. A pet collar allowing for easy attachment and removal of at least one pet tag to the collar, comprising:
a collar with a D-ring,
a clasp with an attachment end and a clasp end,
wherein the clasp is permanently fixed to the collar at the attachment end by the D-ring;
wherein the clasp end is configured to provide for releasable attachment of the at least one pet tag; and
a pet tag releasable attachable to the clasp end:
thereby providing for the quick and easy releasable attachment of the pet tag without the need for tools.

2. The device of claim 1, wherein the clasp is a spring-loaded clasp.

3. The device of claim 1, wherein the at least one pet tag is selected from the group consisting of information tags, vaccination tags, name tags, address tags, RFID devices, microchips, decorative tags, and combinations thereof.

4. The device of claim 1, wherein the clasp is a swivel clasp.

5. The device of claim 1, wherein the clasp is a spring-loaded swivel clasp.

6. A pet collar allowing for easy attachment and removal of at least one pet tag to the collar, comprising:
a collar,
a clasp with an attachment end and a clasp end,
wherein the clasp is permanently fixed to the collar at the attachment end; and
wherein the clasp end is configured to provide for releasable attachment of the at least one pet tag; and
a pet tag releasably attachable to the clasp end,
thereby providing for the quick and easy releasable attachment of the at least one pet tag without the need for tools.

7. The device of claim 6, wherein the clasp is a spring-loaded clasp.

8. The device of claim 6, wherein the at least one pet tag is selected from the group consisting of information tags, vaccination tags, name tags, address tags, RFID devices, microchips, decorative tags, and combinations thereof.

9. The device of claim 6, wherein the clasp is a swivel clasp.

10. The device of claim 6, wherein the clasp is a spring-loaded swivel clasp.

11. A method for releasably securing at least one pet tag to a pet collar, the method steps comprising:
affixing a collar with a clasp with an attachment end and a clasp end around the neck of a pet so that the clasp end is available for attachment to a pet tag;
opening the clasp;
inserting the clasp through a hole in the at least one pet tag; and
closing the clasp;
thereby making a quick and easy releasable attachment of the at least one pet tag to the collar without the need for tools.

12. The method of claim 11, wherein the clasp is a spring-loaded clasp.

13. The method of claim 11, wherein the at least one pet tag is selected from the group consisting of information tags, vaccination tags, name tags, address tags, RFID devices, microchips, decorative tags, and combinations thereof.

14. The method of claim 11, wherein the clasp is a swivel clasp.

15. The method of claim 11, wherein the clasp is a spring-loaded swivel clasp.

16. The method of claim 11, wherein affixing the collar around the neck of a pet is subsequent to the opening, inserting and closing steps.
